(19) United States
(12) Patent Application Publication
(10) Pub. No.: US 2026/0169416 A1
(43) Pub. Date: Jun. 18, 2026

(54) SHEET FEEDING CONTROL METHOD, SHEET FEEDING DEVICE, AND IMAGE FORMING APPARATUS

(71) Applicant: KYOCERA Document Solutions Inc., Osaka (JP)

(72) Inventors: Sueaki Okamoto, Osaka (JP); Yuta Kitabayashi, Osaka (JP); Yuji Kamiyama, Osaka (JP); Yuji Toyota, Osaka (JP); Takeshi Arakawa, Osaka (JP)

(21) Appl. No.: 19/422,872

(22) Filed: Dec. 17, 2025

(30) Foreign Application Priority Data
Dec. 18, 2024 (JP) 2024-221483

(51) Int. Cl. G03G 15/00

(52) U.S. Cl. CPC G03G 15/6511; G03G 15/55; G03G 2215/00599; G03G 2215/00721

(57) ABSTRACT

The sheet detecting device detects sheets at a detection position on a downstream side of a feeding rotating body in a sheet feeding direction. A timing device measures an elapsed time from a time when a feeding process for each sheet is started to a time when each sheet is detected by the sheet detecting device. A control device derives a reference feeding time based on one or more reference measurement times measured by the timing device when one or more reference feeding processes that satisfy a count condition are executed. The control device adjusts, based on the reference feeding time, a timing at which a feeding mechanism starts the feeding process for each of the sheets fed by the feeding process after the reference feeding process has been executed.

### INCORPORATION BY REFERENCE

This application is based upon and claims the benefit of priority from the corresponding Japanese Patent Application No. 2024-221483 filed on Dec. 18, 2024, the entire contents of which are incorporated herein by reference.

### BACKGROUND

The present disclosure relates to a sheet feeding control method for controlling sheet feeding timing, a sheet feeding device, and an image forming apparatus.

The image forming apparatus includes a sheet conveying device and a printing device that forms an image on a conveyed sheet. The sheet conveying device includes a sheet feeding device that feeds a topmost sheet of a stack of sheets to a conveying path, and a plurality of sets of conveying roller pairs that convey the sheet along the conveying path.

The sheet feeding device includes a sheet detecting device that detects the sheet fed to the conveying path. It is known that the image forming apparatus measures feeding speed of the sheet based on the detection result by the sheet detecting device.

### SUMMARY

A sheet feeding control method according to one aspect of the present disclosure is a method for controlling a sheet feeding device. The sheet feeding device includes a feeding mechanism, a lift mechanism, a sheet detecting device, and a timing device. The feeding mechanism has a feeding rotating body that contacts an upper surface of a topmost sheet of a stack of sheets, and executes a feeding process of feeding each sheet from the stack of sheets to a conveying path by rotating the feeding rotating body. The lift mechanism lifts the stack of sheets to a contact position where an upper surface of a topmost sheet of the stack of sheets contacts the feeding rotating body. The sheet detecting device detects each sheet at a position on a downstream side of the feeding rotating body in a sheet feeding direction. The timing device measures an elapsed time from a time when the feeding process for each sheet is started to a time when each sheet is detected by the sheet detecting device. The sheet feeding control method includes a control device deriving a reference feeding time based on one or more reference measurement times measured by the timing device when one or more reference feeding processes are executed that satisfy a count condition that the one or more feeding processes are executed a predetermined number of times since the lift mechanism lifted the stack of sheets to the contact position. Furthermore, the sheet feeding control method includes the control device adjusting, based on the reference feeding time, a feeding start timing at which the feeding mechanism starts the feeding process for each of the sheets fed by the feeding process after the reference feeding process has been executed.

A sheet feeding device according to another aspect of the present disclosure includes the feeding mechanism, the lift mechanism, the sheet detecting device, the timing device, and the control device that achieves the sheet feeding control method.

An image forming apparatus according to another aspect of the present disclosure includes the sheet feeding device and a printing device that forms an image on each sheet fed by the sheet feeding device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment.

FIG. 2 is a block diagram showing a configuration of a control device in an image forming apparatus according to an embodiment.

FIG. 3 is a configuration diagram of a sheet feeding device in an image forming apparatus according to an embodiment.

FIG. 4 is a diagram showing the sheet feeding device before a feeding process is started in an image forming apparatus according to an embodiment.

FIG. 5 is a flowchart showing an example of a procedure for sheet feeding control in an image forming apparatus according to an embodiment.

FIG. 6 is a flowchart showing an example of a procedure for a first timing adjustment process in an image forming apparatus according to an embodiment.

FIG. 7 is a flowchart showing an example of a positional deviation determination process in an image forming apparatus according to an embodiment.

FIG. 8 is a flowchart showing an example of a procedure for a second timing adjustment process in an image forming apparatus according to an embodiment.

FIG. 9 is a diagram showing a first example of a relationship between a reference feeding time, a target measurement time, and a positional deviation time in an image forming apparatus according to an embodiment.

FIG. 10 is a diagram showing a second example of a relationship between a reference feeding time, a target measurement time, and a positional deviation time in an image forming apparatus according to an embodiment.

FIG. 11 is a diagram showing a third example of a relationship between a reference feeding time, a target measurement time, and a positional deviation time in an image forming apparatus according to an embodiment.

FIG. 12 is a diagram showing a fourth example of a relationship between a reference feeding time, a target measurement time, and a positional deviation time in an image forming apparatus according to an embodiment.

FIG. 13 is a diagram showing a fifth example of a relationship between a reference feeding time, a target measurement time, and a positional deviation time in an image forming apparatus according to an embodiment.

FIG. 14 is a flowchart showing a procedure of a modification of the first timing adjustment process.

### DETAILED DESCRIPTION

Hereinafter, an embodiment according to the present disclosure will be described with reference to the drawings. Note that the following embodiment is an example of a specific embodiment according to the present disclosure, and does not limit the technical scope of the present disclosure.

### Configuration of Image Forming Apparatus 10

The image forming apparatus 10 according to an embodiment includes a sheet feeding device 2, a sheet conveying device 3, and a printing device 4. Furthermore, the image forming apparatus 10 includes a control device 8, an operation device 801, a display device 802, and the like.

The image forming apparatus 10 further includes a main housing 1 that houses the sheet feeding device 2, the sheet conveying device 3, and the printing device 4. The main housing 1 includes a lower housing 1a that forms the housing of the sheet feeding device 2.

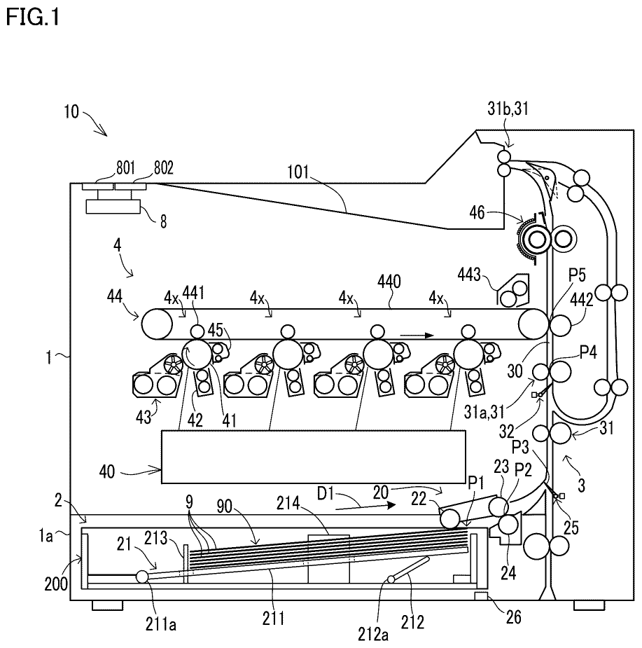

The sheet feeding device 2 includes a sheet cassette 200, a feeding mechanism 20, a lift mechanism 21, and a fed sheet detecting device 25 (see FIG. 1). The feeding mechanism 20 includes a pickup roller 22, a feed-out roller 23, and a retard roller 24.

The sheet cassette 200 stores a stack of sheets 90 and is attached to the lower housing 1a so as to be removable. The sheet cassette 200 is an example of a sheet accommodating unit.

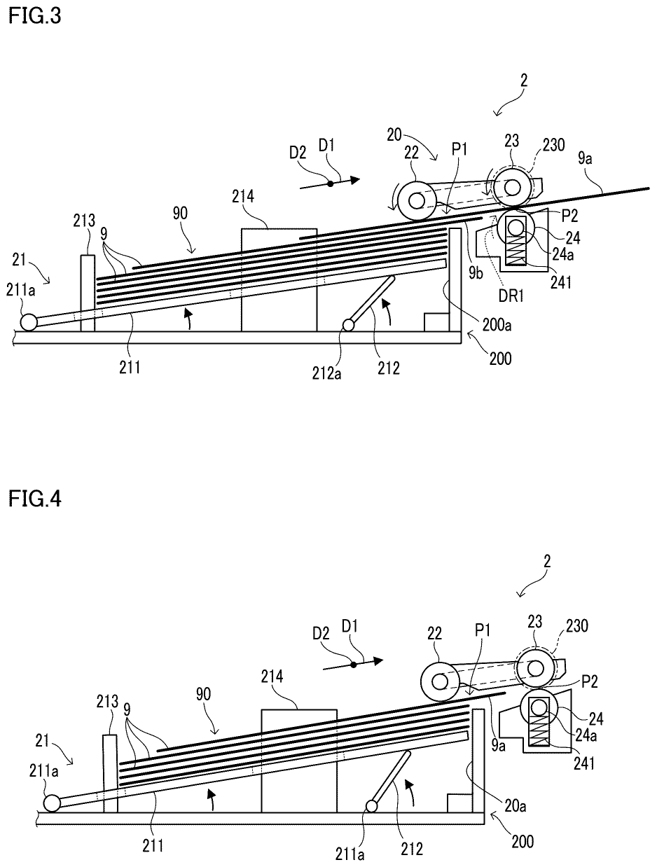

The pickup roller 22 and the feed-out roller 23 are each rotatably supported and arranged at a distance from each other. The pickup roller 22 comes in contact with an upper surface of a topmost sheet in the stack of sheets 90. The feeding mechanism 20 further includes a feeding motor 230 that rotates the pickup roller 22 and the feed-out roller 23 (see FIG. 3).

The feeding mechanism 20 executes a feeding process by rotating the pickup roller 22 and the feed-out roller 23. The feeding process is a process of feeding each sheet 9 from the stack of sheets 90 to the conveying path 30. The conveying path 30 is a path for each sheet 9.

The feed-out roller 23 and the retard roller 24 are arranged in an area between the sheet cassette 200 and the conveying path 30. The retard roller 24 is arranged below the feed-out roller 23 and faces the feed-out roller 23. The retard roller 24 forms a nip between the retard roller 24 and the feed-out roller 23 to sandwich each sheet 9 therebetween.

In the sheet feeding device 2, a sheet feeding direction D1 is a direction from the sheet cassette 200 toward the conveying path 30 (see FIG. 1). The feed-out roller 23 is arranged on the downstream side of the pickup roller 22 in the sheet feeding direction D1 (see FIGS. 1 and 3).

The pickup roller 22 is an example of a feeding rotating body. The feed-out roller 23 is an example of a feed-out rotating body that rotates together with the feeding rotating body.

The retard roller 24 is rotatably supported. The feeding mechanism 20 further includes a torque limiter 24a connected to a rotating shaft of the retard roller 24, and a spring 241 that biases the retard roller 24 toward the feed-out roller 23 (see FIG. 3).

When the feeding process is performed, torque in a forward rotation direction DR1 acts on the retard roller 24 from the rotating feed-out roller 23 or each sheet 9 heading toward the conveying path 30.

The torque limiter 24a limits the rotation of the retard roller 24 in the forward rotation direction DR1 when torque acting on the retard roller 24 in the forward rotation direction DR1 is equal to or less than a rated torque (see FIG. 3).

The retard roller 24 comes in contact with a leading edge of one or more accompanying sheets that are fed out together with each sheet 9 when the feeding process is executed, thereby blocking the accompanying sheets. Thus, the retard roller 24 separates the accompanying sheets from each sheet 9. The accompanying sheets are fed out of the sheet cassette 200 in a state where they overlap a lower surface of the topmost sheet in the stack of sheets 90.

Note that in a case in which the torque acting on the retard roller 24 from the rotating feed-out roller 23 or each sheet 9 heading toward the conveying path 30 exceeds the rated torque of the torque limiter 24a, the retard roller 24 rotates in the forward rotation direction DR1. Thus, the feed-out roller 23 or each sheet 9 is prevented from receiving an excessive frictional force from the retard roller 24.

The retard roller 24 is an example of a separating member that separates the accompanying sheets from the topmost sheet of the stack of sheets 90. Note that a non-rotating separation pad may be employed as the separating member instead of the retard roller 24.

In the following description, a position of each sheet 9 when the leading edge of each sheet 9 is aligned with the cassette leading edge wall surface 200a will be referred to as an initial reference position P1 (see FIGS. 1 and 3). The cassette leading edge wall surface 200a is an inner wall surface at an end portion on the downstream side of the sheet cassette 200 in the sheet feeding direction D1. In addition, a position between the feed-out roller 23 and the retard roller 24 is referred to as a separation position P2 (see FIGS. 1 and 3). The separation position P2 can also be said to be the position of the feed-out roller 23 in the sheet feeding direction D1.

The lift mechanism 21 is arranged within the sheet cassette 200 and is supported by the sheet cassette 200. The lift mechanism 21 supports the stack of sheets 90 so that the sheets can be lifted and lowered.

The lift mechanism 21 is a mechanism that lifts the stack of sheets 90 from the separation position to the contact position. The separation position is a position where an upper surface of the topmost sheet in the stack of sheets 90 is separated downward from the pickup roller 22. The contact position is a position where the upper surface of the topmost sheet in the stack of sheets 90 comes in contact with the pickup roller 22.

The lift mechanism 21 includes a lift plate 211 and a push-up plate 212. The lift plate 211 is supported so as to be rotatable about a rotation shaft 211a arranged along a bottom plate of the sheet cassette 200. That is, the lift plate 211 can rotate up and down around the rotation shaft 211a.

The stack of sheets 90 is placed on the lift plate 211. When the lift plate 211 rotates upward, the stack of sheets 90 rotates upward, and when the lift plate 211 rotates downward, the stack of sheets 90 rotates downward.

The push-up plate 212 is arranged below the lift plate 211 and is rotatably supported about a rotation shaft 212a arranged along the bottom plate of the sheet cassette 200. That is, the push-up plate 212 can rotate up and down around the rotation shaft 212a.

The push-up plate 212 is rotated in a first rotation direction by a driving force of a motor (not shown), thereby pushing up the lift plate 211 and the stack of sheets 90 on the lift plate 211 upward. That is, the lift mechanism 21 rotates the push-up plate 212 in the first rotation direction to lift the stack of sheets 90 on the lift plate 211 from the separation position to the contact position.

On the other hand, the push-up plate 212 rotates in a second rotation direction by the driving force of the motor, thereby lowering the lift plate 211 and the stack of sheets 90 on the lift plate 211. That is, the lift mechanism 21 rotates the push-up plate 212 in the second rotation direction, thereby lowering the stack of sheets 90 on the lift plate 211 from the contact position to the separation position.

The fed sheet detecting device 25 detects each sheet 9 fed by the feeding process at a detection position P3 on the downstream side of the feed-out roller 23 in the sheet feeding direction D1. For example, the fed sheet detecting device 25 includes an actuator that is supported so as to be able to pivot, and a photosensor that detects that the actuator has pivoted. The actuator pivots when it comes into contact with each sheet 9 passing through the detection position P3.

The fed sheet detecting device 25 may be a transmission type photosensor or a reflection type photosensor that detects each sheet 9 passing through the detection position P3.

The sheet feeding device 2 further includes an attachment detection device 26 arranged in the lower housing 1a (see FIG. 1). The attachment detection device 26 detects whether the sheet cassette 200 is attached to the lower housing 1a and in an attached state, or is removed from the lower housing 1a and in a non-attached state.

For example, the attachment detection device 26 is a reflective photosensor or a microswitch that detects a part of the sheet cassette 200 in the attached state.

When the sheet cassette 200 is in the attached state, the lift mechanism 21 can lift the stack of sheets 90 to the contact position.

The sheet cassette 200 further includes an end cursor 213 and a pair of side cursors 214. The end cursor 213 is provided so as to be movable along the sheet feeding direction D1. The end cursor 213 is arranged along a rear end of the stack of sheets 90 placed on the lift plate 211. Thus, the end cursor 213 prevents the stack of sheets 90 from shifting from the initial reference position P1 to the upstream side in the sheet feeding direction D1.

The pair of side cursors 214 are provided so as to be capable of moving toward or away from each other in a width direction D2 perpendicular to the sheet feeding direction D1.

The pair of side cursors 214 are arranged at positions along both ends in the width direction D2 of the stack of sheets 90 placed on the lift plate 211. Thus, the pair of side cursors 214 prevent the stack of sheets 90 from shifting from a specific position in the width direction D2.

The sheet conveying device 3 conveys each sheet 9 fed by the sheet feeding device 2 along a conveying path 30. In the present embodiment, the sheet conveying device 3 includes a plurality of sets of conveying roller pairs 31 arranged along the conveying path 30 and a conveyed sheet detecting device 32.

The plurality of sets of conveying roller pairs 31 convey each sheet 9 by rotating. The plurality of sets of conveying roller pairs 31 include a pair of registration rollers 31a and a pair of discharge rollers 31b.

The pair of registration rollers 31a are arranged at a registration position P4 on the conveying path 30. The pair of discharge rollers 31b are arranged at an end portion of the conveying path 30.

The pair of registration rollers 31a temporarily stop each sheet 9 that is fed by the sheet feeding device 2 at the registration position P4, and then sends each sheet 9 to a printing position P5 on the conveying path 30.

The conveyed sheet detecting device 32 detects each sheet 9 that is fed to the conveying path 30 by the sheet feeding device 2 and then proceeds to the registration position P4. The conveyed sheet detecting device 32 has the same configuration as the fed sheet detecting device 25.

The pair of discharge rollers 31b discharge each sheet 9 that has passed through the printing position P5 from the conveying path 30 onto a discharge tray 101. As will be described later, each sheet 9 has an image formed on the sheet 9 at the printing position P5.

The printing device 4 forms an image on each sheet 9 conveyed by the sheet conveying device 3. That is, the printing device 4 forms an image on each sheet 9 fed by the sheet feeding device 2. The printing device 4 forms an image on each sheet 9 at the printing position P5 on the conveying path 30.

In the example shown in FIG. 1, the printing device 4 forms an image on each sheet 9 electrophotographically. In this case, the printing device 4 includes a laser scanning unit 40, one or more image forming portions 4x, a transfer device 44, and a fixing device 46.

In the example shown in FIG. 1, the printing device 4 includes a plurality of image forming portions 4x corresponding to a plurality of developing colors. Each image forming portion 4x includes a drum-shaped photoconductor 41, a charging device 42, a developing device 43 and a drum cleaning device 45. For example, the plurality of developing colors are cyan, yellow, magenta, and black.

In addition, the transfer device 44 includes an intermediate transfer belt 440, a plurality of primary transfer devices 441 corresponding to the plurality of image forming portions 4x, a secondary transfer device 442, and a belt cleaning device 443.

In each image forming portion 4x, the charging device 42 charges a surface of the photoconductor 41. The laser scanning unit 40 forms an electrostatic latent image on the surface of the photoconductor 41 of each image forming portion 4x by scanning with a laser beam.

In each image forming portion 4x, the developing device 43 supplies toner to the surface of the photoconductor 41 to develop the electrostatic latent image into a toner image.

The primary transfer device 441 transfers the toner image on the surface of the photoconductor 41 of each image forming portion 4x onto a surface of the intermediate transfer belt 440. Thus, the toner images of the plurality of developing colors are transferred onto the surface of the intermediate transfer belt 440. The secondary transfer device 442 transfers the toner image on the surface of the intermediate transfer belt 440 onto each sheet 9 at the printing position P5. The fixing device 46 applies heat and pressure to the toner image transferred onto each sheet 9 to fix the toner image onto each sheet 9.

In each image forming portion 4x, the drum cleaning device 45 removes waste toner remaining on the surface of the photoconductor 41. The belt cleaning device 443 removes waste toner remaining on the surface of the intermediate transfer belt 440.

Note that the printing device 4 may be a device that forms an image on each sheet 9 using a method other than an electrophotographic method. For example, the printing device 4 may be a device that forms an image on each sheet 9 using an inkjet method.

When an inkjet printing device 4 is employed, the sheet conveying device 3 may include a belt conveying device that conveys each sheet 9 by a rotating endless belt.

The operation device 801 is a device that receives human operations. The operation device 801 includes, for example, operation buttons and a touch panel. The display device 802 is a device that displays information. The display device 802 includes, for example, a panel display device such as a liquid crystal display unit.

The control device 8 executes various types of data processing operations. Furthermore, the control device 8 controls devices such as the sheet feeding device 2, the sheet conveying device 3, the printing device 4, and the display device 802.

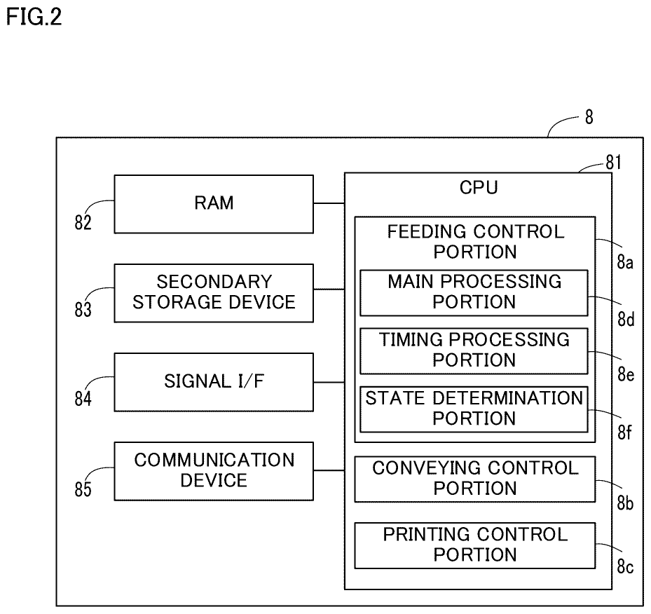

As shown in FIG. 2, the control device 8 includes a central processing unit (CPU) 81, a random access memory (RAM) 82, a secondary storage device 83, a signal interface 84, and other peripheral devices. The control device 8 further includes a communication device 85 and the like.

The CPU 81 is a processor that executes computer programs to execute various types of data processing and control operations. The RAM 82 is a computer-readable volatile storage device. The RAM 82 temporarily stores computer programs executed by the CPU 81 and data output and referenced by the CPU 81 in the course of executing various types of processes.

The secondary storage device 83 is a computer-readable non-volatile storage device. The secondary storage device 83 is capable of storing and updating the computer programs and various types of data. For example, one or both of a flash memory and a hard disk drive may be employed as the secondary storage device 83.

The signal interface 84 converts signals output by various types of sensors into digital data and transmits the converted digital data to the CPU 81. Furthermore, the signal interface 84 converts the control command output by the CPU 81 into a control signal, and transmits the control signal to a device to be controlled.

The communication device 85 executes communication with other devices such as a host device through a communication network such as a LAN. The CPU 81 transmits and receives data to and from the other devices via the communication device 85.

The CPU 81 includes a plurality of processing modules that are achieved by executing the computer programs. The plurality of processing modules include a feeding control portion 8a, a conveying control portion 8b, and a printing control portion 8c.

The feeding control portion 8a executes data processing and control related to the sheet feeding device 2. The feeding control portion 8a of the CPU 81 constitutes a part of the sheet feeding device 2.

The conveying control portion 8b executes data processing and control related to the sheet conveying device 3. The conveying control portion 8b of the CPU 81 constitutes a part of the sheet conveying device 3.

The printing control portion 8c executes data processing and control related to the printing device 4. The printing control portion 8c of the CPU 81 constitutes a part of the printing device 4.

The feeding control portion 8a includes a main processing portion 8d, a timing processing portion 8e, a state determination portion 8f, and the like.

The main processing portion 8d controls the start and end of the feeding process by controlling the operation and stopping of the feeding motor 230.

For example, when a printing request is input through the operation device 801 or the communication device 85, the main processing portion 8d activates the feeding motor 230 to cause the feeding mechanism 20 to start the feeding process.

The printing request may be a request to execute a single printing process or a request to execute a continuous printing process. The single printing process is a process in which an image is formed on one sheet 9. The continuous printing process is a process in which images are formed continuously on each of a plurality of sheets 9.

The timing processing portion 8e executes a first timing process for measuring an elapsed time from a time when the feeding process for each sheet 9 is started to a time when each sheet 9 is detected by the fed sheet detecting device 25. In the present embodiment, the feeding process is started when the feeding motor 230 starts operating.

The timing processing portion 8e is an example of a timing device that executes the first timing process. Note that the timing device may be achieved by other processors such as a digital signal processor (DSP) or circuits such as an application specific integrated circuit (ASIC).

Furthermore, the timing processing portion 8e also executes a second timing process for measuring an elapsed time from a time when each sheet 9 is detected by the fed sheet detecting device 25.

When the printing request is a request to execute a continuous printing process, the main processing portion 8d controls the timing of starting the second and subsequent feeding processes based on the time measured by the second timing process. Thus, each sheet 9 is fed to the conveying path 30 at an appropriate interval.

The state determination portion 8f executes a process of determining a state of feeding of each sheet 9 by the sheet feeding device 2. In the present embodiment, the state determination portion 8f determines the state of feeding of each sheet 9 by the sheet feeding device 2 based on the measurement time T1 by the first timing process.

The printing control portion 8c controls the laser scanning unit 40 to control the process of forming the electrostatic latent image on the surface of the photoconductor 41 of each of the plurality of image forming portions 4x. Thus, the printing control portion 8c controls the timing at which the toner image is formed on the surface of the photoconductor 41 of each of the plurality of image forming portions 4x.

The conveying control portion 8b stops the rotation of the registration roller pair 31a in response to detection of a sheet 9 by the conveyed sheet detecting device 32, and then rotates the registration roller pair 31a in response to the timing at which the toner image is formed in each of the plurality of image forming portions 4x. Thus, the conveying control portion 8b executes control to feed out each sheet 9 from the registration position P4 to the printing position P5 in synchronization with the timing at which the toner image is formed in each of the plurality of image forming portions 4x.

In the sheet feeding device 2, a delay in feeding each sheet 9 may occur due to deterioration of parts that come into contact with each sheet 9. More specifically, deterioration of the pickup roller 22 or the feed-out roller 23 may cause the pickup roller 22 or the feed-out roller 23 to slide on the top surface of each sheet 9, resulting in a delay in feeding each sheet 9.

A delay state of feeding each sheet 9 affects a sheet interval. The delay state may also vary due to factors other than deterioration of the parts of the sheet feeding device 2.

In order to correctly determine the deterioration state of the sheet feeding device 2 or to properly maintain the sheet interval, it is desirable to be able to correctly determine the delay state.

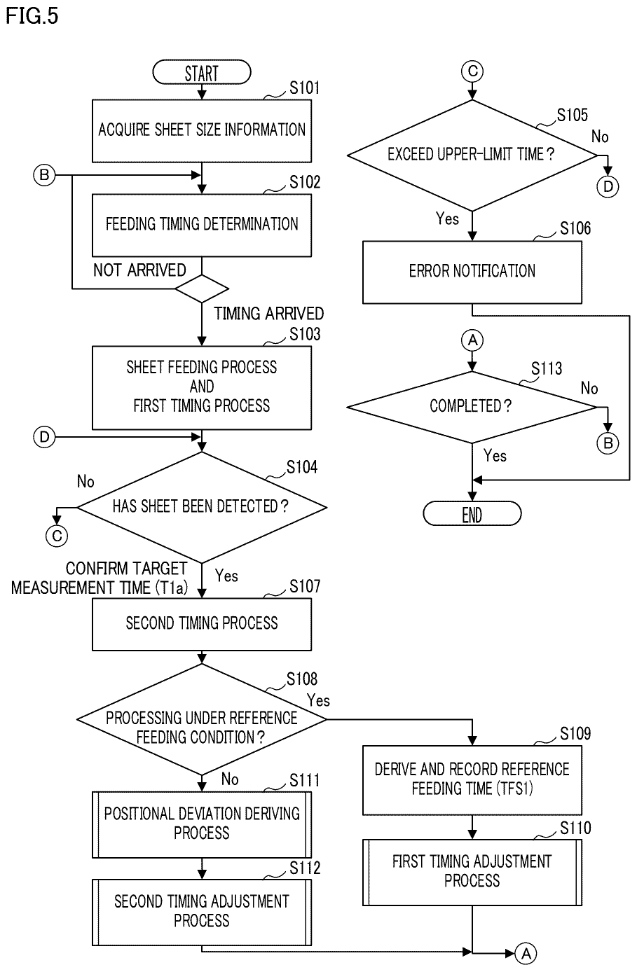

In the sheet feeding device 2, a feeding control portion 8a executes sheet feeding control, which will be described later (see FIG. 5). Thus, the sheet feeding control includes a process for correctly determining the delay state that varies due to causes other than deterioration of parts of the sheet feeding device 2.

In the following description, one sheet of the stack of sheets 90 that is a target of the sheet feeding process will be referred to as a target sheet 9a (see FIGS. 3 and 4). The target sheet 9a is the topmost sheet in the stack of sheets 90. The target sheet 9a is also a sheet that is a target of the first timing process and the second timing process.

In addition, the sheet to be fed next to the target sheet 9a in the stack of sheets 90 and will become the target of the next feeding process is referred to as a next sheet 9b (see FIG. 3). The next sheet 9b is the second sheet from the top of the stack of sheets 90.

### Sheet Feeding Control

An example of the sheet feeding control procedure will be described below with reference to the flowchart shown in FIG. 5. The sheet feeding control is executed by the feeding control portion 8a.

The sheet feeding control procedure is an example of a procedure for achieving a sheet feeding control method for controlling the sheet feeding device 2. The sheet feeding control procedure includes a procedure for achieving a sheet feeding state determination method.

In the present embodiment, the control device 8 including the feeding control portion 8a is an example of a device that achieves the sheet feeding control method. The main processing portion 8d starts the sheet feeding control when the printing request is input via the operation device 801 or the communication device 85.

In the following description, S101, S102, and so on represent identification codes of a plurality of steps in the sheet feeding control. In the sheet feeding control, first, the process of step S101 is executed.

### <Step S101>

In step S101, the main processing portion 8d acquires pre-registered sheet size information from the secondary storage device 83. The sheet size information is information that indicates the size of the stack of sheets 90 accommodated in the sheet cassette 200.

For example, the sheet size information includes reference size information selected from a plurality of reference size candidates and sheet orientation information indicating orientation of the stack of sheets 90. The reference size information is information that specifies vertical and horizontal dimensions of the stack of sheets 90, and the sheet orientation information indicates whether the length of the stack of sheets 90 in the sheet feeding direction D1 is the vertical dimension or the horizontal dimension.

That is, the sheet size information includes sheet length information that indicates the length of the stack of sheets 90 accommodated in the sheet cassette 200 in the sheet feeding direction D1. The length indicated by the sheet length information is the vertical dimension or the horizontal dimension in the reference size information.

The main processing portion 8d inputs the sheet size information in advance via the operation device 801 or the communication device 85 and registers the sheet size information in the secondary storage device 83.

After executing the process of step S101, the main processing portion 8d shifts the process to step S102.

### <Step S102>

In step S102, the main processing portion 8d determines whether the feeding timing has arrived or not.

For example, the feeding timing is an initial feeding timing or a subsequent feeding timing. The initial feeding timing is timing when the printing device 4 is ready to operate after the printing request is input.

The subsequent feeding timing is timing at which feeding of the second and subsequent sheets 9 starts when the printing request is a request for a continuous printing process.

More specifically, the subsequent feeding timing is the timing at which the second measurement time corresponding to the immediately previous feeding process reaches a feeding waiting time. The feeding waiting time is time required from a time when the leading edge of each sheet 9 reaches the detection position P3 until a trailing edge of each sheet 9 exceeds the position along the cassette leading edge wall surface 200a by a predetermined amount.

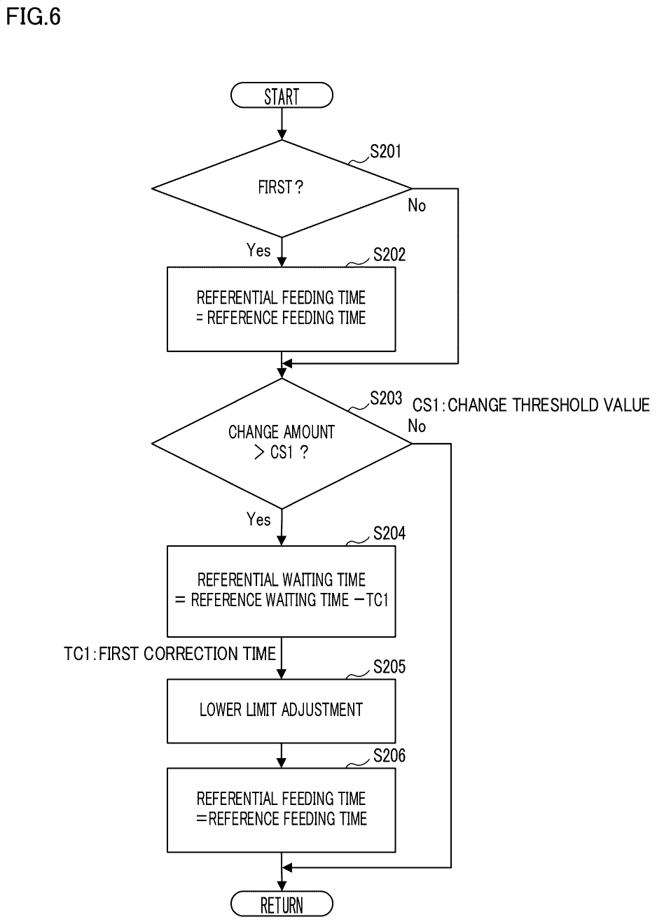

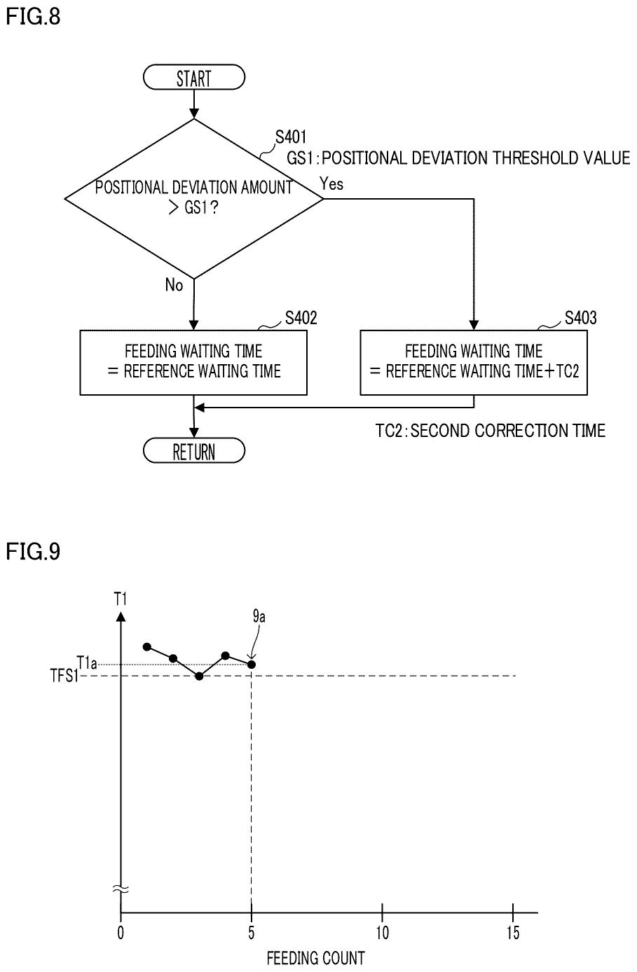

In step S101, the main processing portion 8d sets an initial waiting time, which is one of a plurality of preset candidate waiting times that corresponds to the sheet length information, as the feeding waiting time. Note that in the first timing adjustment process or the second timing adjustment process described later, the feeding waiting time may be adjusted (see FIGS. 6 and 8).

The main processing portion 8d waits until it is determined that the feeding timing has arrived. When it is determined that the feeding timing has arrived, the main processing portion 8d shifts the processing to step S103.

### <Step S103>

In step S103, the main processing portion 8d causes the feeding mechanism 20 to start the feeding process. Thus, the pickup roller 22 and the feed-out roller 23 are rotated, and the target sheet 9a in the stack of sheets 90 is fed from the lift plate 211 toward the conveying path 30 (see FIG. 3).

Furthermore, when the feeding process is started in step S103, the timing processing portion 8e starts the first timing process.

After executing the process of step S103, the main processing portion 8d shifts the process to step S104.

### <Step S104>

In step S104, in a case in which the fed sheet detecting device 25 transitions from the no-sheet detection state to the sheet detecting state, the timing processing portion 8e shifts the process to step S107.

The timing processing portion 8e ends the first timing process when the fed sheet detecting device 25 transitions to the sheet detection state. Thus, the timing processing portion 8e determines a target measurement time T1a, which is the result of the first timing process for the target sheet 9a (see FIGS. 9 to 12).

FIGS. 9 to 12 show an example of the transition of the target measurement time T1a according to the feeding count when the feeding process is repeated.

In step S104, in a case in which the fed sheet detecting device 25 does not transition from the no-sheet detection state to the sheet detecting state, the timing processing portion 8e shifts the process to step S105. In this case, the timing processing portion 8e continues the first timing process.

### <Step S105>

In step S105, the timing processing portion 8e selects the next process depending on whether or not the time measured by the first timing process has exceeded a preset upper limit time. The upper limit time is a time used to detect an empty feeding state in which the feeding mechanism 20 cannot feed a target sheet 9a.

In a case in which the time measured by the first timing process does not exceed the upper limit time, the timing processing portion 8e shifts the process to step S104. Thus, the timing processing portion 8e continues the first timing process until the fed sheet detecting device 25 transitions from the no-sheet detection state to the sheet detection state, provided that the time measured by the first timing process does not exceed the upper limit time.

On the other hand, in a case in which the time measured by the first timing process exceeds the upper limit time under the condition that the fed sheet detecting device 25 does not transition to the sheet detection state, the timing processing portion 8e shifts the process to step S106.

### <Step S106>

In step S106, the main processing portion 8d outputs an error notification indicating that the empty feeding state has occurred via one or both of the display device 802 and the communication device 85.

Each of the display device 802 and the communication device 85 is an example of an information output device.

After executing the process of step S106, the main processing portion 8d ends the feeding control. Thus, the feeding control is stopped.

### <Step S107>

In step S107, the timing processing portion 8e starts the second timing process.

After executing the process of step S107, the main processing portion 8d shifts the process to step S108.

Note that when the processing from step S107 onwards is being executed, the conveying control portion 8b causes the sheet conveying device 3 to execute the process of conveying the target sheet 9a along the conveying path 30, and the printing control portion 8c causes the printing device 4 to execute the process of forming an image on the target sheet 9a.

### <Step S108>

In step S108, the state determination portion 8f selects the next process depending on whether the feeding process executed in step S103 corresponds to one or more reference feeding processes that satisfy a predetermined reference feeding condition.

The reference feeding condition is a condition indicating a situation in which there is no positional deviation of the target sheet 9a from the initial reference position P1 at the time the feeding process is started, or the positional deviation is assumed to be small enough to be negligible.

When the feeding process is executed, the next sheet 9b may be fed out as the accompanying sheet from the initial reference position P1 in the sheet feeding direction D1 (see FIG. 3). In this case, the position of the next sheet 9b deviates in the sheet feeding direction D1 with respect to the initial reference position P1. The next sheet 9b in which the positional deviation occurs is fed as a new target sheet 9a in the next feeding process.

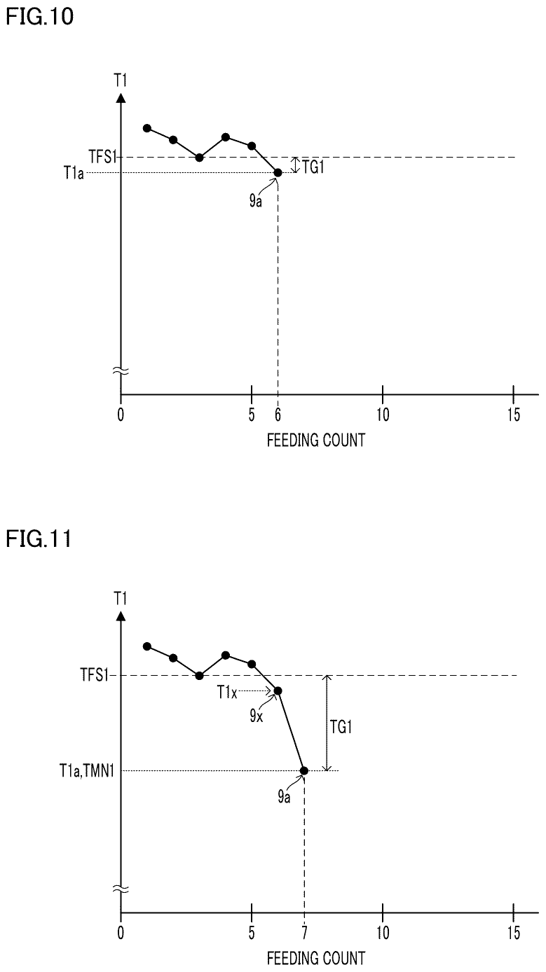

When the target sheet 9a in which the positional deviation occurs is fed, the target measurement time T1a is shorter than when the target sheet 9a in which the positional deviation does not occur is fed. FIGS. 9 and 10 show an example in which the target measurement time T1a in the sixth feeding process is shorter than the measurement time T1 in the fifth feeding process because the positional deviation of the next sheet 9b occurred in the fifth feeding process.

In addition, FIGS. 10 to 12 show an example in which the positional deviation of the target sheet 9a increases as the number of feeding processes increases. As shown in FIGS. 9 to 12, when the number of times the feeding process is performed after the lift mechanism 21 lifts the stack of sheets 90 to the contact position is small, the positional deviation of the target sheet 9a often does not occur or is small.

In the present embodiment, the reference feeding condition includes a count condition that the feeding process is performed one time or multiple times after the lift mechanism 21 lifts the stack of sheets 90 to the contact position.

For example, the count condition is a condition that the feeding process is executed for the first or second time after the lift mechanism 21 lifts the stack of sheets 90 to the contact position. Alternatively, the count condition is a condition that the feeding process is executed from the i-th to j-th time after the lift mechanism 21 lifts the stack of sheets 90 to the contact position. i and j are positive integers less than 10, for example.

In addition, in the first feeding process in a state where the lift mechanism 21 lifts the stack of sheets 90 to the contact position, a relatively long target measurement time T1a may be measured. Therefore, excluding the first feeding process from the count condition is conceivable.

In addition, the reference feeding condition may be a logical product of an attachment condition regarding the attachment of the sheet cassette 200 and the count condition. The attachment condition is that the feeding process is executed one or more times when the lift mechanism 21 first lifts the stack of sheets 90 to the contact position after the detection result of the attachment detection device 26 changes from the non-attached state to the attached state.

The lift mechanism 21 lowers the stack of sheets 90 from the contact position to the separation position before the sheet cassette 200 is pulled out from the lower housing 1a. Usually, when the sheet cassette 200 is pulled out from the lower housing 1a, an operation to replenish the stack of sheets 90 or an operation to align the stack of sheets 90 is performed.

Therefore, under the circumstances where both the attachment condition and the count condition are met, there is a higher possibility that the positional deviation of the target sheet 9a has not occurred.

In a case in which the feeding process executed in step S103 is the reference feeding process, the state determination portion 8f shifts the process to step S109. On the other hand, in a case in which the feeding process executed in step S103 does not correspond to one or more reference feeding processes, the state determination portion 8f shifts the process to step S111.

### <Step S109>

In step S109, the state determination portion 8f derives a reference feeding time TFS1 based on one or more target measurement times T1a measured when the reference feeding process is executed one or more times.

For example, the state determination portion 8f derives one target measurement time T1a measured when the reference feeding process is executed one time as the reference feeding time TFS1.

Alternatively, the state determination portion 8f sets the reference feeding time TFS1 as a representative value of a plurality of target measurement times T1a measured when the reference feeding process is executed a plurality of times. For example, the representative value of the plurality of target measurement times T1a is an average value, minimum value, or median value of the plurality of target measurement times T1a.

Furthermore, the state determination portion 8f records information about the set reference feeding time TFS1 in the secondary storage device 83.

The reference feeding time TFS1 is a reference value of the target measurement time T1a in the feeding process under a situation where the positional deviation of the target sheet 9a does not occur or the positional deviation is assumed to be negligibly small.

The reference feeding time TFS1 is used to determine whether or not the positional deviation of each sheet 9 has occurred, and to derive the amount of positional deviation.

The amount of positional deviation is the amount of deviation of the position of each sheet 9 from the initial reference position P1 at the time when the feeding process of each sheet 9 is started.

Note that the initial value of the reference feeding time TFS1 is a predetermined reference time. The predetermined reference time is a time determined by a designed feeding speed of the feeding mechanism 20 and a path length from the initial reference position P1 to the detection position P3.

In the present embodiment, the designed feeding speed is a speed when a reference sheet having a reference sheet length in the sheet feeding direction D1 is fed.

The one or more target measurement times T1a measured by the timing processing portion 8e when the reference feeding process is executed one or more times are examples of one or more reference measurement times. In the present embodiment, one or more of the reference measurement times are used to derive a reference feeding time TFS1.

Note that the target measurement time T1a that will be the target of processing in step S112 described later is the time measured by the timing processing portion 8e for the target sheet 9a that is fed after one or more reference feed sheets have been fed. From the time when the process of step S107 is executed until the time when the process of step S112 is executed, the lift mechanism 21 maintains the stack of sheets 90 at the contact position.

After executing the process of step S109, the state determination portion 8f shifts the process to step S110.

### <Step S110>

In step S110, the main processing portion 8d executes the first timing adjustment process, which will be described later (see FIG. 6). The first timing adjustment process is a process for adjusting the timing of starting the feeding process for the next sheet 9b based on the reference feeding time TFS1.

After executing the process of step S110, the main processing portion 8d shifts the process to step S113.

### <Step S111>

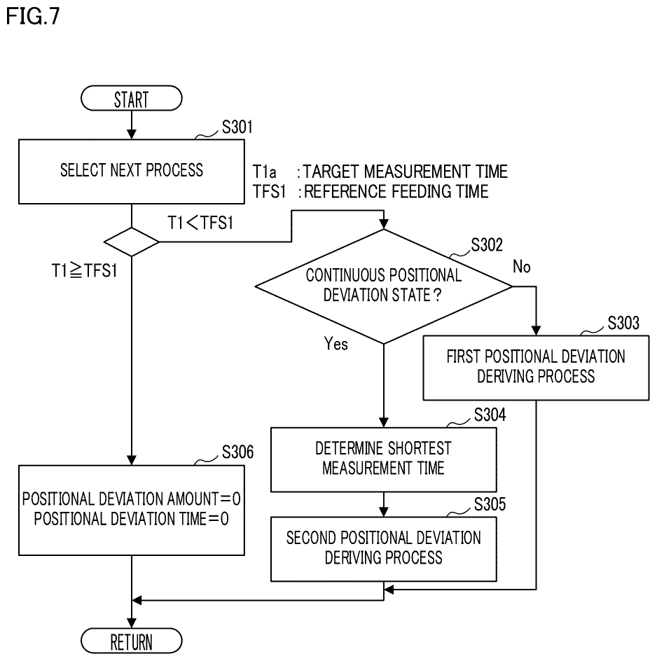

On the other hand, in step S113, the state determination portion 8f executes a positional deviation deriving process, which will be described later (see FIG. 7). The positional deviation deriving process is a process for deriving the positional deviation amount for the target sheet 9a that is fed after the reference feeding process is executed.

After executing the process of step S111, the state determination portion 8f shifts the process to step S112.

### <Step S112>

In step S112, the second timing adjustment process, which will be described later is executed (see FIG. 8). The second timing adjustment process is a process for adjusting the timing of starting the feeding process for the next sheet 9b based on the amount of positional deviation.

After executing the process of step S112, the main processing portion 8d shifts the process to step S113.

### <Step S113>

In step S113, the main processing portion 8d selects the next process depending on whether or not all the feeding processes corresponding to the printing requests have been completed.

In a case in which all of the feeding processes corresponding to the printing requests have not yet been completed, the main processing portion 8d shifts the processing to step S102. In this case, in step S102, the main processing portion 8d executes a process of determining the subsequent feeding timing based on the result of the second timing process started in step S107.

On the other hand, when all the feeding processes corresponding to the printing request have been completed, the main processing portion 8d ends the sheet feeding control.

### First Timing Adjustment Process

Next, an example of a procedure for the first timing adjustment process will be described with reference to the flowchart shown in FIG. 6.

In the following description, S201, S202, and so on represent identification codes of a plurality of steps in the first timing adjustment process. In the first timing adjustment process, first, the process of step S201 is executed.

### <Step S201>

In step S201, the main processing portion 8d selects the next process depending on whether or not the process of deriving the reference feeding time TFS1 executed in step S109 is the first process.

In a case in which the process of deriving the reference feeding time TFS1 executed in step S109 is the first process, the main processing portion 8d shifts the process to step S202. That is, the main processing portion 8d shifts the process to step S202 in a case in which the reference feeding time TFS1 obtained in step S109 is the first obtained reference feeding time TFS1.

On the other hand, in a case in which the process of deriving the reference feeding time TFS1 executed in step S109 is a second or subsequent process, the main processing portion 8d shifts the process to step S203.

### <Step S202>

In step S202, the main processing portion 8d sets the first obtained reference feeding time TFS1 as a referential feeding time, and records information on the latest referential feeding time in the secondary storage device 83. The referential feeding time is used to derive the amount of change in the reference feeding time TFS1 in step S203.

After executing the process of step S202, the main processing portion 8d shifts the process to step S203.

### <Step S203>

In step S203, the main processing portion 8d selects the next process depending on whether or not the amount of change in the reference feeding time TFS1 exceeds a predetermined change threshold value.

In step S203, the main processing portion 8d derives the difference between the reference feeding time TFS1 and the referential feeding time as the change amount. More specifically, the change amount is derived by subtracting the referential feeding time from the reference feeding time TFS1.

When the change amount in the reference feeding time TFS1 exceeds the change threshold value, the main processing portion 8d shifts the process to step S204. On the other hand, when the change amount in the reference feeding time TFS1 does not exceed the change threshold value, the main processing portion 8d ends the first timing adjustment process.

### <Step S204>

In step S204, the main processing portion 8d changes the reference waiting time to be shorter. The initial value of the reference waiting time is the initial waiting time (see step S102).

In the present embodiment, the main processing portion 8d sets the time obtained by subtracting a first correction time from the reference waiting time as a new reference waiting time. The first correction time is a predetermined time.

As will be described later, the reference waiting time is a time that serves as a reference for the feeding waiting time. In the second timing adjustment process, the reference waiting time or a time obtained by correcting the reference waiting time is set as the feeding waiting time (see FIG. 8).

After executing the process of step S204, the main processing portion 8d shifts the process to step S205.

### <Step S205>

In step S205, the main processing portion 8d adjusts the reference waiting time so that it does not fall below a predetermined lower limit time.

That is, in a case in which the reference waiting time corrected in step S204 is below the lower limit time, the main processing portion 8d sets the lower limit time as the reference waiting time.

After executing the process of step S205, the main processing portion 8d shifts the process to step S206.

### <Step S206>

In step S206, the main processing portion 8d sets the most recently obtained reference feeding time TFS1 as the referential feeding time. Thus, in the next first timing adjustment process, the change amount of the reference feeding time TFS1 is derived using the referential feeding time last set in step S206 (see step S203).

After executing the process of step S206, the main processing portion 8d ends the first timing adjustment process.

### Positional Deviation Deriving Process

Next, an example of a procedure for the positional deviation deriving process will be described with reference to the flowchart shown in FIG. 7.

In the following description, S301, S302, and so on represent identification codes of a plurality of steps in the positional deviation deriving process. In the positional deviation deriving process, first, the process of step S301 is executed.

### <Step S301>

In step S301, the state determination portion 8f compares the target measurement time T1a with the reference feeding time TFS1 to select the next process.

In a case in which the target measurement time T1a is shorter than the reference feeding time TFS1, the state determination portion 8f shifts the processing to step S302. On the other hand, in a case in which the target measurement time T1a is not shorter than the reference feeding time TFS1, the state determination portion 8f shifts the processing to step S306.

The state in which the target measurement time T1a is shorter than the reference feeding time TFS1 is a positional deviation state in which the target sheet 9a is located on the downstream side in the sheet feeding direction D1 relative to the initial reference position P1 at the time the feeding process of the target sheet 9a is started. The state in which the target measurement time T1a is not shorter than the reference feeding time TFS1 is a no positional deviation state in which the positional deviation state does not occur.

### <Step S302>

In step S302, the state determination portion 8f selects the next process depending on whether or not a continuous positional deviation state occurs. FIGS. 11 to 13 show an example of the continuous positional deviation state.

The continuous positional deviation state is a state in which one or more most recent measurement times T1x and the target measurement time T1a are shorter than the reference feeding time TFS1.

The one or more most recent measurement times T1x are times measured by the first timing process of the timing processing portion 8e for one sheet or multiple consecutive most recent fed sheets 9x that are fed immediately before the target sheet 9a is fed.

FIG. 11 shows an example in which, when the target measurement time T1a is the measurement time T1 obtained in the seventh feeding process, the most recent measurement time T1x obtained in the previous feeding process and the target measurement time T1a are shorter than the reference feeding time TFS1.

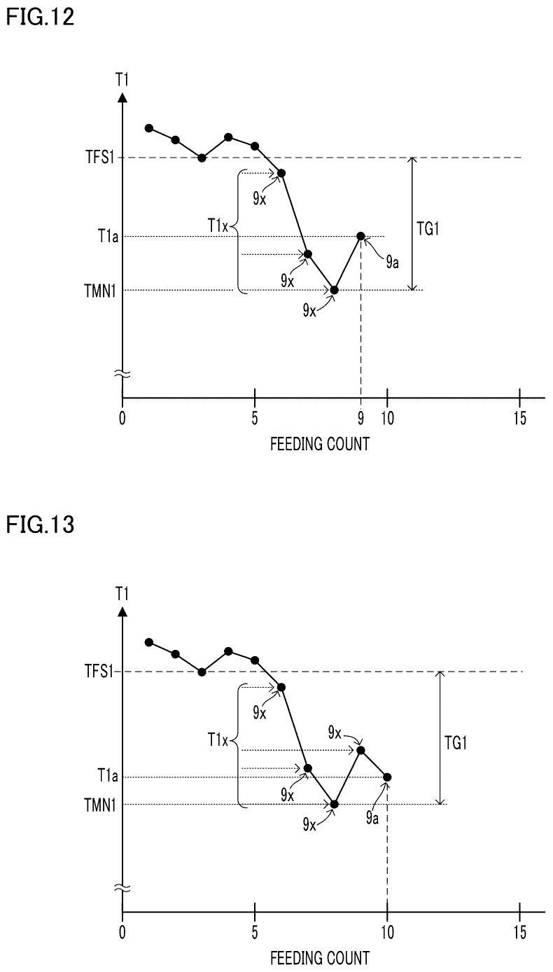

FIG. 12 shows an example in which, when the target measurement time T1a is the measurement time T1 obtained in the ninth feeding process, the three most recent measurement times T1x obtained in the feeding processes from three processes before to the one before and the target measurement time T1a are less than the reference feeding time TFS1.

FIG. 13 shows an example in which, when the target measurement time T1a is the measurement time T1 obtained in the 10th feeding process, the four most recent measurement times T1x obtained in the feeding processes from four processes before to the one before that and the target measurement time T1a are less than the reference feeding time TFS1.

In a case in which the continuous positional deviation state does not occur, the state determination portion 8f shifts the process to step S303. On the other hand, in a case in which the continuous positional deviation state occurs, the state determination portion 8f shifts the process to step S304.

### <Step S303>

In step S303, the state determination portion 8f executes a first positional deviation deriving process. The first positional deviation deriving process is a process for deriving an amount of positional deviation according to a difference between the target measurement time T1a and the reference feeding time TFS1.

The first positional deviation deriving process includes a process of deriving the difference between the target measurement time T1a and the reference feeding time TFS1 as a positional deviation time TG1 (see FIGS. 10 and 11). The positional deviation time TG1 is the time required to feed the target sheet 9a by a distance corresponding to the positional deviation amount.

Furthermore, the first positional deviation deriving process includes a process of deriving the amount of positional deviation by multiplying the positional deviation time TG1 by the reference feeding speed. Note that the positional deviation time TG1 may be derived as the positional deviation amount.

The reference feeding speed is derived by dividing a path length from the initial reference position P1 to the detection position P3 by the reference feeding time TFS1. Note that the state determination portion 8f may derive the reference feeding speed in advance in step S109.

After executing the process of step S303, the state determination portion 8f ends the positional deviation deriving process.

### <Step S304>

On the other hand, in step S304, the state determination portion 8f identifies the shortest measurement time TMN1, which is the shortest time among one or more most recent measurement times T1x and the target measurement time T1a (see FIGS. 11 to 13).

After executing the process of step S304, the state determination portion 8f shifts the process to step S305.

### <Step S305>

In step S305, the state determination portion 8f executes a second positional deviation deriving process. The second positional deviation deriving process is a process for deriving the amount of positional deviation based on a difference between the target measurement time T1a and the shortest measurement time TMN1.

The second positional deviation deriving process includes a process of deriving the difference between the target measurement time T1a and the shortest measurement time TMN1 as the positional deviation time TG1 (see FIG. 12). Furthermore, the second positional deviation deriving process includes a process of deriving the positional deviation amount by multiplying the positional deviation time TG1 by the reference feeding speed.

In many cases, after the positional deviation of each sheet 9 occurs, the positional deviation amount remains the same or increases each time the feeding process is executed until the leading edge of each sheet 9 reaches the retard roller 24. Usually, the positional deviation of each sheet 9 is not eliminated by the feeding process.

On the other hand, even in a case in which the positional deviation amount does not change, the target measurement time T1a may become longer due to the pickup roller 22 and the feed-out roller 23 sliding on the upper surface of the target sheet 9a.

The second positional deviation deriving process is a process that derives the positional deviation amount under the assumption that when the continuous positional deviation state occurs, the shortest measurement time TMN1 represents a reduction in feeding time caused by the positional deviation amount of the target sheet 9a.

After executing the process of step S305, the state determination portion 8f ends the positional deviation deriving process.

### <Step S306>

On the other hand, in step S306, the state determination portion 8f sets the positional deviation amount to 0, and also sets the positional deviation time TG1 to 0.

After executing the process of step S306, the state determination portion 8f ends the positional deviation deriving process.

### Second Timing Adjustment Process

Next, an example of a procedure for the second timing adjustment process will be described with reference to the flowchart shown in FIG. 8.

In the following description, S401 to S403 represent identification codes of three steps in the second timing adjustment process. In the second timing adjustment process, first, the process of step S401 is executed.

### <Step S401>

In step S401, the main processing portion 8d selects the next process depending on whether or not the positional deviation amount derived by the positional deviation deriving process exceeds a preset positional deviation threshold value.

For example, a value less than a separation path length, which is a path length from the initial reference position P1 to the separation position P2, is set as the positional deviation threshold value. In addition, the separation path length or a value greater than the separation path length may be set as the positional deviation threshold value.

For example, in a case in which the positional deviation amount represents the positional deviation, the positional deviation threshold value is the separation path length or a value obtained by correcting the separation path length with a correction coefficient. In a case in which the positional deviation amount is the positional deviation time TG1, the positional deviation threshold value is a required time obtained by dividing the separation path length by the reference feeding speed or a value obtained by correcting the required time with a correction coefficient.

In a case in which the positional deviation amount does not exceed the positional deviation threshold value, the main processing portion 8d shifts the process to step S402. On the other hand, in a case in which the positional deviation amount exceeds the positional deviation threshold value, the main processing portion 8d shifts the process to step S403.

### <Step S402>

In step S402, the main processing portion 8d sets the reference waiting time as the feeding waiting time. After executing the process of step S402, the main processing portion 8d ends the second timing adjustment process.

### <Step S403>

On the other hand, in step S403, the main processing portion 8d sets the time obtained by correcting the reference waiting time as the feeding waiting time.

In the present embodiment, the main processing portion 8d sets the time obtained by adding a second correction time to the reference waiting time as the feeding waiting time. For example, the second correction time is a deviation time obtained by dividing the positional deviation amount by the reference feeding speed, or a time obtained by correcting the deviation time by a correction coefficient. In addition, the second correction time may be a predetermined time.

After executing the process of step S403, the main processing portion 8d ends the second timing adjustment process.

As described above, the main processing portion 8d adjusts the timing at which the feeding mechanism 20 starts the feeding process for each sheet 9 fed by the feeding process after the reference feeding process has been executed, based on the reference feeding time TFS1 (see steps S110, S201 to S206, S401 to S403 and S102).

In the present embodiment, the main processing portion 8d changes the feeding start timing when the change amount in the reference feeding time TFS1 exceeds the change threshold value (see step S204). Note that the process of step S204 of changing the feeding waiting time by changing the reference waiting time is an example of a process of changing the feeding start timing.

Furthermore, the main processing portion 8d adjusts the feeding start timing at which the feeding mechanism 20 starts the feeding process for the next sheet 9b following the target sheet 9a in accordance with the positional deviation amount of the target sheet 9a (see steps S111 to S112, steps S401 to S403, and step S102). Note that the processes of steps S402 and S403 for changing the feeding waiting time are an example of a process for changing the feeding start timing.

In the present embodiment, in a case in which the positional deviation amount of the target sheet 9a does not exceed the positional deviation threshold value, the main processing portion 8d causes the feeding mechanism 20 to start the feeding process for the next sheet 9b by the processes of step S402 and step S102.

In steps S402 and S102, the main processing portion 8d causes the feeding mechanism 20 to start the feeding process for the next sheet 9b when the measurement time of the second timing process for the target sheet 9a has exceeded the feeding waiting time set in step S402.

On the other hand, in a case in which the positional deviation amount of the target sheet 9a exceeds the positional deviation threshold value, the main processing portion 8d causes the feeding mechanism 20 to start the feeding process for the next sheet 9b by the processes of step S403 and step S102.

In steps S403 and S102, the main processing portion 8d causes the feeding mechanism 20 to start the feeding process for the next sheet 9b when the measurement time of the second timing process for the target sheet 9a has exceeded the feeding waiting time set in step S403.

The feeding waiting time set in step S402 is an example of a first waiting time, and the feeding waiting time set in step S403 is an example of a second waiting time that is longer than the first waiting time.

By executing the first timing adjustment process, an appropriate sheet interval is ensured even in a case in which a delay occurs in feeding each of the sheets 9. As a result, a decrease in performance of the continuous printing process due to the sheet interval being too large is avoided.

In addition, by executing the second timing adjustment process, an appropriate sheet interval is ensured even in a case in which the initial position each of the sheets 9 is deviated. As a result, it is possible to avoid double sheet feeding and sheet jamming caused by the sheet interval being too narrow.

### Modification of First Timing Adjustment Process

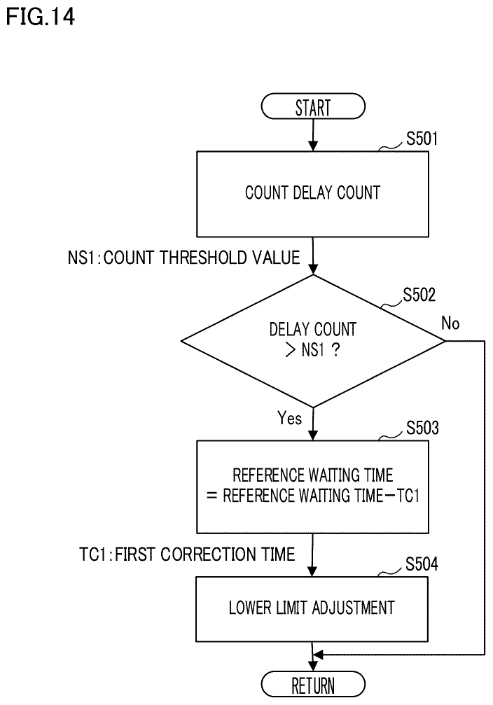

Next, an example of a procedure for a modification of the first timing adjustment process will be described with reference to the flowchart shown in FIG. 14.

In the following description, S501, S502, and so on represent identification codes of a plurality of steps in a modification of the first timing adjustment process. In the modification of the first timing adjustment process, first, the process of step S501 is executed.

### <Step S501>

In step S501, the main processing portion 8d counts a delay count, which is the number of times the reference feeding time TFS1 exceeds a preset delay threshold value, and records information on the delay count in the secondary storage device 83.

That is, the main processing portion 8d counts up the delay count when the reference feeding time TFS1 exceeds the delay threshold value.

After executing the process of step S501, the main processing portion 8d shifts the process to step S502.

### <Step S502>

In step S502, the main processing portion 8d selects the next process depending on whether or not the delay count exceeds a preset count threshold value.

In a case in which the delay count exceeds the count threshold value, the main processing portion 8d shifts the process to step S503. On the other hand, in a case in which the delay count does not exceed the count threshold value, the main processing portion 8d ends the first timing adjustment process.

In step S502, the main processing portion 8d may derive a delay frequency based on the delay count, and select the next process depending on whether or not the delay frequency exceeds a preset frequency threshold value.

For example, the delay frequency is a ratio of the delay count to a period during which the feeding process is executed a predetermined unit number of times. The delay count is an example of a frequency at which the reference feeding time TFS1 exceeds the delay threshold value.

In a case in which the delay frequency is derived, the main processing portion 8d shifts the process to step S503 when the delay frequency exceeds the frequency threshold value. On the other hand, in a case in which the delay frequency does not exceed the frequency threshold value, the main processing portion 8d ends the first timing adjustment process.

### <Step S503>

In step S503, the main processing portion 8d changes the reference waiting time to be shorter. The initial value of the reference waiting time is the initial waiting time (see step S102).

In the present embodiment, the main processing portion 8d sets the time obtained by subtracting the first correction time from the reference waiting time as a new reference waiting time.

As described above, the reference waiting time is used to set the feeding waiting time in the second timing adjustment process (see FIG. 8).

After executing the process of step S503, the main processing portion 8d shifts the process to step S504.

### <Step S504>

In step S504, the main processing portion 8d adjusts the reference waiting time so as not to fall below the lower limit time, similarly to step S205.

After executing the process of step S504, the main processing portion 8d ends the first timing adjustment process.

In the present modification, the main processing portion 8d changes the feeding start timing in a case in which the count or frequency at which the reference feeding time TFS1 exceeds the delay threshold value exceeds the count threshold value or frequency threshold value (see step S503). Note that the process of step S503 of changing the feeding waiting time by changing the reference waiting time is an example of a process of changing the feeding start timing.

When the present modification is adopted, the same effects as when the first timing adjustment process shown in FIG. 6 is adopted can be obtained.

### Supplementary Notes

An outline of the technique according to the disclosure extracted from the above-described embodiments will be added below. Note that the configurations and processing functions described in the following supplementary notes can be selected and combined as desired.

### Supplementary Note 1

A sheet feeding control method for controlling a sheet feeding device that includes:
a feeding mechanism having a feeding rotating body that contacts an upper surface of a topmost sheet of a stack of sheets, and configured to execute a feeding process of feeding each sheet from the stack of sheets to a conveying path by rotating the feeding rotating body;
a lift mechanism configured to lift the stack of sheets to a contact position where an upper surface of a topmost sheet of the stack of sheets contacts the feeding rotating body;
a sheet detecting device configured to detect each sheet at a position on a downstream side of the feeding rotating body in a sheet feeding direction; and
a timing device configured to measure an elapsed time from a time when the feeding process for each sheet is started to a time when each sheet is detected by the sheet detecting device;
the sheet feeding control method including:
a control device deriving a reference feeding time based on one or more reference measurement times measured by the timing device when one or more reference feeding processes are executed that satisfy a count condition that the one or more feeding processes are executed a predetermined number of times since the lift mechanism lifted the stack of sheets to the contact position; and
the control device adjusting, based on the reference feeding time, a feeding start timing at which the feeding mechanism starts the feeding process for each of the sheets fed by the feeding process after the reference feeding process has been executed.

### Supplementary Note 2

The sheet feeding control method according to Supplementary Note 1, wherein
the control device changes the feeding start timing when a change amount of the reference feeding time exceeds a threshold value.

### Supplementary Note 3

The sheet feeding control method according to Supplementary Note 1, wherein
the control device changes the feeding start timing when the count or frequency at which the reference feeding time exceeds a delay threshold value exceeds a count threshold value or a frequency threshold value.

### Supplementary Note 4

The sheet feeding control method according to any one of Supplementary Notes 1 to 3, wherein
when the sheet feeding device includes:
a sheet accommodating unit configured to support the lift mechanism, accommodate the stack of sheets, and be attached to a housing of the sheet feeding device so as to be removable; and
an attachment detection device configured to detect whether the sheet accommodating unit is in an attached state of being attached to the housing or in a non-attached state of being pulled out from the housing;
one or a plurality of reference feeding processes satisfy an attachment condition and the count condition, that is, the one or more reference feeding processes are executed when the lift mechanism first lifts the stack of sheets to the contact position after a detection result of the attachment detection device changes from the non-attached state to the attached state.

### Supplementary Note 5

A sheet feeding device, including:
a feeding mechanism having a feeding rotating body that contacts an upper surface of a topmost sheet of a stack of sheets, and configured to execute a feeding process of feeding each sheet from the stack of sheets to a conveying path by rotating the feeding rotating body;
a lift mechanism configured to lift the stack of sheets to a contact position where an upper surface of the topmost sheet of the stack of sheets contacts the feeding rotating body;
a sheet detecting device configured to detect each sheet at a position on a downstream side of the feeding rotating body in a sheet feeding direction;
a timing device configured to measure an elapsed time from a time when the feeding process for each sheet is started to a time when each sheet is detected by the sheet detecting device; and
a control device configured to achieve the sheet feeding control method according to any one of Supplementary Notes 1 to 4.

### Supplementary Note 6

An image forming apparatus, including:
the sheet feeding device according to Supplementary Note 5; and
a printing device configured to form an image on each sheet fed by the sheet feeding device.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A sheet feeding control method for controlling a sheet feeding device, comprising:
a feeding mechanism having a feeding rotating body that contacts an upper surface of a topmost sheet of a stack of sheets, and configured to execute a feeding process of feeding each sheet from the stack of sheets to a conveying path by rotating the feeding rotating body;
a lift mechanism configured to lift the stack of sheets to a contact position where an upper surface of a topmost sheet of the stack of sheets contacts the feeding rotating body;
a sheet detecting device configured to detect each sheet at a position on a downstream side of the feeding rotating body in a sheet feeding direction; and
a timing device configured to measure an elapsed time from a time when the feeding process for each sheet is started to a time when each sheet is detected by the sheet detecting device;
the sheet feeding control method comprising:
a control device deriving a reference feeding time based on one or more reference measurement times measured by the timing device when one or more reference feeding processes are executed that satisfy a count condition that the one or more feeding processes are executed a predetermined number of times since the lift mechanism lifted the stack of sheets to the contact position; and
the control device adjusting, based on the reference feeding time, a feeding start timing at which the feeding mechanism starts the feeding process for each of the sheets fed by the feeding process after the reference feeding process has been executed.

2. The sheet feeding control method according to claim 1, wherein
the control device changes the feeding start timing when a change amount of the reference feeding time exceeds a threshold value.

3. The sheet feeding control method according to claim 1, wherein
the control device changes the feeding start timing when the count or frequency at which the reference feeding time exceeds a delay threshold value exceeds a count threshold value or a frequency threshold value.

4. The sheet feeding control method according to claim 1, comprising:
when the sheet feeding device comprises:
a sheet accommodating unit configured to support the lift mechanism, accommodate the stack of sheets, and be attached to a housing of the sheet feeding device so as to be removable; and
an attachment detection device configured to detect whether the sheet accommodating unit is in an attached state of being attached to the housing or in a non-attached state of being pulled out from the housing;
one or a plurality of reference feeding processes satisfy an attachment condition and the count condition, that is, the one or more reference feeding processes are executed when the lift mechanism first lifts the stack of sheets to the contact position after a detection result of the attachment detection device changes from the non-attached state to the attached state.

5. A sheet feeding device comprising:
a feeding mechanism having a feeding rotating body that contacts an upper surface of a topmost sheet of a stack of sheets, and configured to execute a feeding process of feeding each sheet from the stack of sheets to a conveying path by rotating the feeding rotating body;
a lift mechanism configured to lift the stack of sheets to a contact position where an upper surface of a topmost sheet of the stack of sheets contacts the feeding rotating body;
a sheet detecting device configured to detect each sheet at a position on a downstream side of the feeding rotating body in a sheet feeding direction;
a timing device configured to measure an elapsed time from a time when the feeding process for each sheet is started to a time when each sheet is detected by the sheet detecting device;
and a control device configured to achieve the sheet feeding control method according to claim 1.

6. An image forming apparatus, comprising:
the sheet feeding device according to claim 5; and
a printing device configured to form an image on each sheet fed by the sheet feeding device.
